(19) United States
(12) Patent Application Publication
(10) Pub. No.: US 2005/0275997 A1
(43) Pub. Date: Dec. 15, 2005

(54) Plasma driven, N-Type semiconductor, thermoelectric power superoxide ion generator

(76) Inventor: Douglas Burke, Newport Beach, CA (US)

Correspondence Address: Douglas Burke, 2507 Port Whitby, Newport Beach, CA, 92660, US

(21) Appl. No.: 10/867,296

(22) Filed: Jun. 14, 2004

(51) Int. Cl. H02H 1/00

(52) U.S. Cl. 361/220

(57) ABSTRACT

A plasma is generated inside a barrier enclosure made specifically of N-Type semiconductive material, said plasma thus generating a thermal gradient across said barrier which drives electrons through said barrier via the thermoelectric power of said N-Type semiconductor, said electrons thus being liberated on the opposing side of said barrier where they interact with oxygen in the air to form the superoxide ion,

### FIELD OF THE INVENTION

The proposed invention is a means of generating ions in the air at atmospheric pressure. In particular the species of ion generated is the superoxide ion, O₂⁻. The superoxide ion being the desired species because of its ability to accommodate the benefit of cleaning the air. Simultaneously, the superoxide ion, O₂⁻ does not have the harmful effects of ozone, O₃, to humans.

### BACKGROUND OF THE INVENTION AND PRIOR ART

There are various and sundry means of generating oxygen species ions. These involve arc discharge through the air. An early discourse on such discharge phenomenon is found in the text, “The Discharge of Electricity Through Gases,” Charles Scribner's Sons, New York: 1899. S.S. Thompson, “Lord Kelvin.” Another text is “Fundamental Processes of Electrical Discharge in Gases,” Leob, Leonard, B., John Wiley and Sons, 1939.

A more recent text, “Spark Discharge” by Bazelyan et al; explains the phenomenon of streamers quite nicely. The problem in discharging electricity through air is that air is stubborn. It takes energy to start the arc which results in a type of avalanche breakdown. This avalanche breakdown produces as arc in which electrons have a lot of energy. This is undesirable because these electrons can cleave molecular oxygen, O₂, in half to produce atomic oxygen, O. This atomic oxygen can then react with molecular oxygen to produce ozone. Ozone is unwanted because of its proposed harmful effects to humans.

The proposed invention liberates electrons into the air at a low energy. Avalanche dielectric breakdown of the air is absent. The superoxide ion is formed in abundance as opposed to ozone.

Techniques of producing ions in air usually involve a sharp needlelike electrode. At the tip of such a needle the electric field gets very high and dielectric breakdown occurs. These needles can be coated with platinum and gently pulsed to limit ozone production. As a result, superoxide ion generation is also limited. Further, the small surface area of the needle head limits ion production.

Needlelike electrodes in ionization devices are ever present. For pending art see U.S. patent App. No. 20040025695 to Zhang at al. Therein find discussion of a plurality of wires and ground plates at high voltage to produce dielectric breakdown of the air and thus generate ions. Also is found a discussion of the point ionizer. Both of these techniques involve high voltage exposed to the raw air to produce ions. These devices however also produce ozone. The high voltage arcing through the raw air produces ozone because of the phenomenon of avalanche.

Pulsed corona discharge microwave plasma, and dielectric barrier discharge devices are all reviewed in detail in “Prospects for non-Thermal atmospheric plasmas for pollution abatement”, McAdams, J. Phys. D.: Applied Physics, 34 (2001) 2810-2821. The pulsed corona discharge and the microwave discharge device involve passing the raw air through the corona and or plasma. This will produce ozone. This is why these devices clean the air, ozone being a powerful oxidant. However, if there are no contaminants in the air the ozone does not get used and itself is a contaminant.

The dielectric barrier discharge device DBD shown in FIG. 1, referring to FIG. 1, find a first electrode, 101, a dielectric barrier, 103, a second electrode, 105, a region between the insulating dielectric barrier and the second electrode where air can pass, 107, and a power supply, 109.

In the dielectric barrier or silent discharge regime, one of the two electrodes has an insulating coating on it and an alternating current (ac) voltage is applied between the electrodes. The microdischarges occur between the insulating surface and the opposing electrode. These microdischarges have a duration of ˜1-10 ns and are self-quenching. They appear as spikes on the current waveform. For a given applied voltage, the capacitances of the insulating layer and the gap between the layer and the opposing electrode together with the applied frequency determine the power dissipation. Such dielectric barrier discharges have formed the basis of commercial ozone generators, with the ozone being used for water treatment for example.

The proposed invention is not a dielectric barrier discharge device. It has a plasma in an enclosed volume and the barrier is a specific material to execute specific phenomenon.

The short discharge pulses in region, 107, have a lot of energy and split molecular oxygen in half to the end of producing ozone.

Another device that has been in production for many years is the ionization tube made by Bentax of Switzerland. The device seems to generate superoxide ions but if the voltage is turned up to produce more ions ozone production begins. How the Bentax tube operates is not part of the public domain knowledge. Certainly the public Bentax literature doe not explain the ion production mechanism. It claims that negative oxygen clusters are formed in addition to positive ion clusters. These are mysteriously formed on the surface of the tube as air is passed over the tube. These positively and negatively charged clusters then move off into the air and clean it. Bentax claims the original inventor of its tube is Albert Einstein.

We now review and analyze the Bentax technology to explain how it works and thereby to reveal the novel differences of the proposed invention which allows it to outperform the Bentax tube, and to be manufactured at a fraction of the cost.

Referring to FIG. 2, the Bentax tube (concentric cylindrical geometry) comprises a first electrode, 111, enclosed by a first electrode, 113, a second electrode, 115, a region between the first electrode and the glass, 117, a region between the glass and the second electrode, 119, and a power supply, 121. The volume is filled with an unknown gas. The inner electrode has holes in it to allow the gas to pass into the region, 117. The outer electrode is a mesh that is grounded. A two to three kilovolt 60Hz signal is put on the inner electrode. The signal varies above and below ground equally as a sign wave. A plasma is formed in the region, 117. Then positive and negative ions are formed outside the tube. Since the time averaged electric field across the barrier is zero the electric field is not driving any charged particles through the barrier. The barrier is quartz, doped with 0.8% Na and 0.8% K as impurities. This makes the barrier a P-Type semiconductor. The charge carrier in quartz doped with Na is known to be the Na+ ion. The thickness of the barrier is 0.6 mm. Under these conditions the sodium ions will migrate toward the plasma and or the inside of the tube. This is because the thermoelectric current in a P-Type semiconductor is towards the high temperature region as sodium cations flow towards the plasma and leave the glass a negative charge will also have to leave the glass to preserve charge neutrality. A portion of these negative charges will be electrons and will appear on the outer surface of the barrier where they can be picked up by an oxygen molecule and become superoxide ions, O₂⁻. The tube however also produces positive ions in abundance. This indicates that the field in region, 119, in FIG. 2, is also actively ionizing the air by the means similar to the dielectric barrier discharge devices described earlier. The dielectric barrier discharge mechanism is the primary means of ion production for the tube. The population migration of sodium ions through the glass is a small secondary mechanism. The disadvantages of the Bentax system are:
(a) The quartz doped with 0.8% Na and 0.8% K is not a standard glass and must be made by specialty order. This makes it expensive to manufacture.
(b) The doped quartz glass is very brittle and is prone to breakness easily and or developing microcracks.
(c) The thermoelectric power of the doped quartz is small and transporting sodium ions through the glass to liberate electrons is an inefficient way of liberating electrons into the open air. The thermoelectric effect of ion transmission is not an obvious mechanism nor probably was it the intended mechanism. If it were a P-Type semiconductor it would never have been chosen as the barrier material. They certainly would not continue to make it that way for forty years if it were obvious how to improve it.
(d) The dielectric barrier discharge, DBD, effect is the primary mechanism at producing ions outside the tube. If the voltage is turned up to get more ions the tube will start to produce ozone like the DBD devices.
(e) Since the mechanism in the DBD devices is also present, positive as well as negative ions will be produced. The positive ions are undesirable. The ion of interest is the superoxide ion, O₂⁻, which is negative.

The proposed invention overcomes all of the disadvantages of the Bentax tube. It represents novel improvements that make the dominant mechanism of ion production a result of electron transport through the glass.

### BRIEF DESCRIPTION OF DRAWINGS

FIG. 1: Schematic of dielectric barrier discharge device

FIG. 2: Schematic of ion tube from prior art

FIG. 3: Schematic of plasma position

FIG. 4: Mixed frequency waveform

FIG. 5: Negative square wave pulse train

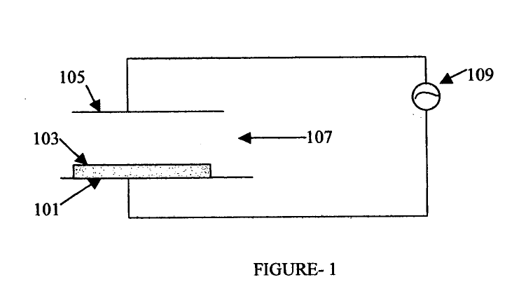

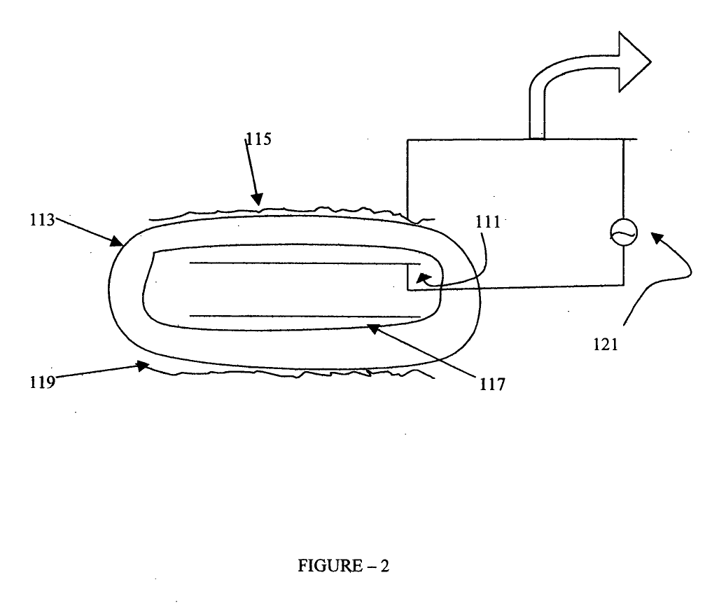

### OBJECTS AND ADVANTAGES

Accordingly several objects and advantages of the proposed invention are:
(a) The proposed invention comprises a plasma bound by a barrier wherein electrons are transported through the barrier by virtue of the thermoelectric power of the barrier. The barrier is an N-Type semiconductor instead of a P-Type semiconductor.
The charge carrier of the barrier in the proposed invention is the electron. It is possible to get a higher current of electrons through such a barrier than sodium ions through the P-Type barrier of the prior art. A higher current of electrons translates into a production of more superoxide ions.
(b) The primary mechanism of ion production is electron transport through the glass. The electron appears at the surface with a low energy. It collides with O₂ molecules and they capture it to become superoxide, O₂⁻. The energy input into the device goes onto heating the plasma to create the temperature gradient which drives electrons through the glass. The energy is not used to generate dielectric barrier discharge, which can generate ozone. Thus the proposed invention generates about ten times less ozone per unit energy input into the device that is for equal voltages and thickness of barrier. At the same time it produces about ten times more superoxide ions,
(c.) In one of its embodiments the proposed invention uses borosilicate glass (pyrex) instead of quartz doped with 0.8% sodium and 0.8% potassium. The pyrex is many times less expensive because it is manufactured on a mass scale. Thus the proposed invention constitutes a new use for pyrex.
(d) The primary mechanism of ion production is the transport of electrons through the barrier. Thus a higher transport of electrons can be achieved by floating the inner electrode at a negatively biased DC offset. This establishes a net electric field across the barrier that does not time average out to zero. There is a net electric field producing a net force on electrons. This additional force increases the electron diffusion through the barrier which gives rise to more ions.
(e) In the proposed invention it is electron transport through the barrier and onto the surface of the tube that produces ions. The temperature gradient across the barrier pushes the electrons through the barrier. Thus increasing the temperature gradient can increase the ion production. The temperature of the plasma is maximized by driving the plasma at the plasma frequency. This is a critical resonant condition that results in an improvement of the ion output. The critical resonant frequency is a function of the density of the gas inside the tube and the partial ionization of the plasma.
(f) The inner electrode of the plasma in the proposed invention can be floated at a negative bias D.C. offset below ground. This serves to provide means for the device to produce mostly negative ions. The negative D.C. offset provides an electric field that drives more electrons through the glass. More electron transmission gives rise to more ion production.
(g) The proposed invention in some of its permutations drives the inner electrode with a mixture of frequencies. A first frequency to maximize the temperature of the plasma. A second frequency to maximize electron conductivity through the barrier.
(h) Because pyrex glass with its enhanced strength is used in one of the embodiments of the proposed invention, the plasma can be run at higher densities. The density of the gas can be two or three atmospheres. This increased density enhances electron diffusion through the barrier. Thus ion production on the surface is increased.

### DETAILED DESCRIPTION OF THE INVENTION

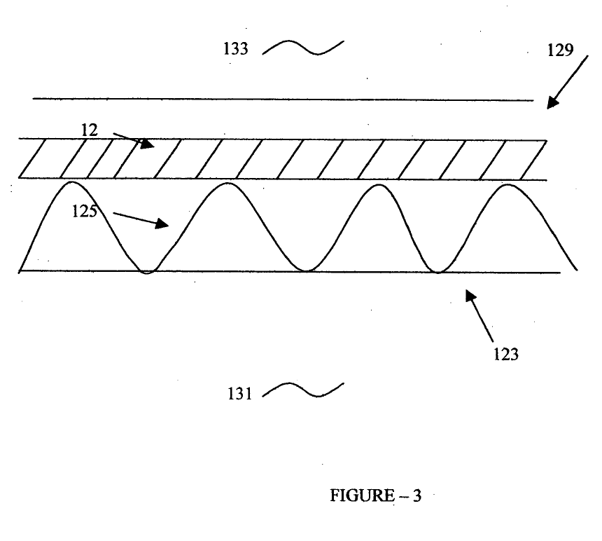

Referring to FIG. 3, the proposed invention comprises a first region containing a gas, 131, a first electrode permeable by said gas, 123, a plasma, 125, formed by exciting said first electrode with a voltage, a barrier, 127, which separates said first region, 131, from a second region, 133, and a grounded second electrode, 129, and said second region being the open air of the room where the device is placed.

Said barrier is a material which is an N-Type semiconductor wherein the majority charge carries is the electron.

In one embodiment of the proposed invention the barrier is composed of borosilicate glass. In another embodiment the barrier is a lead oxide glass or any of the known glass or ceramic materials which share N-Type semiconductors wherein the charge carrier is the electron. In another embodiment the barrier has a thin coating of a ceramic material like Yitrium doped zirconium oxide. The zirconium oxide layer serving to damp out the kinetic energy of electrons as they move through the barrier onto its surface.

A first group of electronically conducting glasses consist of oxide glasses with relatively large concentrations of transitron metal oxides, such as vanadium phosphate glasses.

A second group of electron glasses consists of sulphides, selenides, and tellurides. These are known as the chalcogenide glasses. These glasses are semiconductors but their electronic conductivity is not critically dependent on trace impurities as it is in the classical semiconductors. However, with the transition metal oxide glasses there is generally a dependence on the degree of reduction or oxidation during melting; the conductivity is generally at a maximum for a certain ratio of oxidized to reduced valence state of the transition metal ion. (Linsley, G. S., Owen., A. E. and Hayatee, F. M. (1970). J. Non-Crystalline Solids, 4, 208.

Electronically conducting glasses have a definite thermoelectric effect. This has been observed by Mackenzie. [Mackenzie, J. D. (1964) “Modern Aspects of The Vitreous State”, Vol. 3, p. 126. Butterworth. London.] The thermoelectric power of the barrier turns out to be important as will become obvious in the section on operations of the invention. The temperature gradient across the barrier is the dominant force that drives electrons through the barrier. This electron current is proportional to the product of the thermoelectric power of the material and the temperature gradient.

Other than the above mentioned amorphous semiconductors, the classical N-Type semiconductors can be used. One such example would be silicon doped with phosphorous.

The second electrode must have holes in it or be composed of a metallic mesh. This is so electrons coming to the surface can have some space to move before they hit the second electrode. This allows time for them to be picked up by oxygen molecules in said second region thereby generating the superoxide ion, O₂⁻. To further the production of the superoxide ion the second electrode should be coated with a thin layer of insulator to deter the ground conductor from absorbing electrons. The electrons there remain on the surface of the tube longer until they are picked up by an oxygen molecule in the air.

Other optimum conditions for the production of superoxide ions by the proposed invention include the voltage waveform applied to said first electrode.

The plasma formed inside the tube has a characteristic plasma frequency. Referring to FIG. 3 the plasma is formed in the space, 125, between said first electrode and said barrier. If the voltage on said first electrode varies sinusoidally at the plasma frequency there is maximum energy transfer into the plasma. For a given voltage amplitude the plasma reaches a maximum energy transfer into the plasma. For a given voltage amplitude the plasma reaches a maximum temperature. As the temperature gradient is optimized thermoelectrically driven electron transmission through the barrier is optimized. Superoxide production is optimized.

In another embodiment the voltage on said first electrode varies as shown in FIG. 4. This is a mixture of two frequencies. The low frequency is the plasma frequency and the high frequency is one megahertz or higher. The waveform should have a negative DC offset. The higher frequency component aids in the electric field driven conductivity of the electrons through the barrier.

In another embodiment the voltage varies as in FIG. 4. The low frequency is the plasma frequency. The high frequency is set equal to the speed of sound through the barrier driven by the thickness of said barrier. This is between 500 KHz and 2 MHz for most materials.

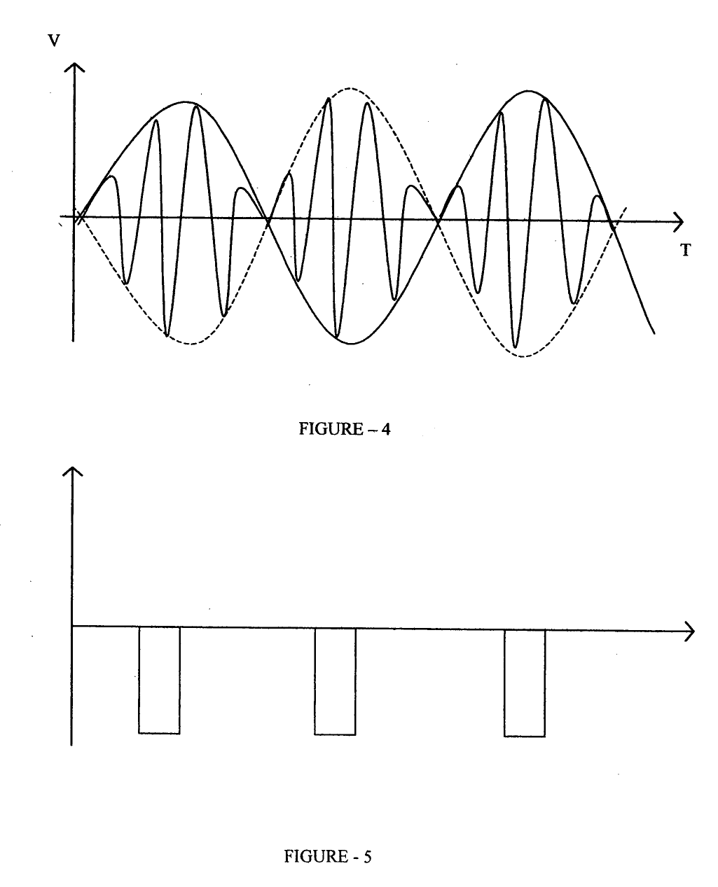

In another embodiment of the proposed invention the voltage varies as in FIG. 5. This is a pulse waveform. The rep rate is set equal to the plasma frequency. One over the pulse width is set equal to the speed of sound divided by the barrier width.

In another embodiment the voltage varies as in FIG. 5. The rep rate is the plasma frequency. One divided by the pulse width is set equal to 1 MHz or higher.

FIG. 4 shall be referred to as a dual mixed harmonic waveform characterized by a low frequency and a high frequency.

FIG. 5 shall be referred to as a pulsed waveform. It is characterized by a rep rate frequency and an inverse pulse width frequency.

Another means of optimizing electron transmission through said barrier is to increase the density of the gas in said region one. Oxygen, nitrogen, air, and argon all produce more electrons on the surface and thereby more ions if the gas density is increased.

### OPERATIONS OF THE INVENTION

Referring to FIG. 3, a voltage is applied to said first electrode, 123, to form plasma, 125. The plasma temperature is greater than the temperature in region two, 133. This establishes a temperature gradient across said barrier. Said barrier is an N-Type semiconductor wherein the majority charge carrier is the electron. Said barrier has a thermoelectric power, P. Thus the temperature gradient pushes electrons from the plasma through said barrier. The electrons appear on the surface of said barrier and interact with the molecular oxygen in said second region, 133. The free electrons plus molecular oxygen produce the superoxide ion, O₂⁻.

One way to provide optimum conditions involves varying the barrier material to enhance electron transmission. Another means to optimize electron transmission is by varying frequency of the voltage waveform on the inner electrode, 123, and by biasing it with a negative average potential. Driving the plasma at its plasma frequency optimizes the energy absorbed by the plasma thus giving it a maximum temperature for a given power input. This allows for maximum electron diffusion via the thermoelectric effect. If the gas in said region one, 131, is air atmospheric pressure the plasma frequency is in the audio frequency range at 2-6 Kv rms voltages.

In addition if the electric field is negatively biased it also drives electrons through the barrier. The conductivity is higher for higher frequencies. This is a characteristic of classical and amorphous semiconductors.

In amorphous semiconductors a first conduction mechanism involves hopping conduction through the localized levels near the Fermi level when the density of states at the Fermi level is finite. A second mechanism is hopping conduction by bipolarons as in the chaleogenide glasses. These conduction mechanisms give a frequency dependent conductivity of the form σ=const W^{S}. Thus higher w (2π\mathring{x} frequency) gives higher conductivity.

A classical semiconductor has a frequency dependent conductivity due to the momentum relaxation time of elections excited onto the conduction band. This relaxation time is on the order of 10⁻¹²-10⁻¹³ sec. Nevertheless megahertz frequencies or higher give appreciably higher conductivities.

The present invention being thus described, it will be obvious that the same may be varied in many ways. Such variations are not to be regarded as a departure from the spirit and scope of the invention and all such modifications as would be obvious to one skilled in the art are intended to be included within the scope of the following claims:

101. A method and system of producing superoxide ions in the air at atmospheric pressure comprising,
a. an enclosed volume of gas, the inside of which comprises a first region, the outside of which comprises a second region, the boundary of which comprises a barrier between said first and second regions and said second region being atmospheric air, and,
b. a first electrode in said first region in close proximity to the inner surface of said barrier such that a first subvolume between said and first electrode and said barrier is established and is small compared to said enclosed volume whose boundary is defined by said barrier, and
c. means for said gas in said first region to pass freely into said first subvolume between said first electrode and said barrier, one such means being holes in said first electrode or other means selected from the group of such obvious equivalent means, and
d. a second electrode on the outer surface of said barrier, and
e. said second electrode having holes so that gas in said second region can move to and from the outer surface of said barrier, and
f. said barrier being an N-Type semiconductor, and
g. the majority charge carrier of said barrier being electrons, and
h. saidbarrier having a thermoelectric power, P, and
i. means for grounding said second electrode and
j. means of applying a voltage of adequate amplitude and periodicity to said first electrode to sustain a partially ionized plasma in said first subvolume, and said plasma having a plasma frequency, fₚ, and
k. said plasma having a temperature, Tₚ, and
l. said second region having a temperature T, and
m. Tp being greater than T, thus establishing a temperature gradient, ΔT, across said barrier, and
n. the amplitude and periodicity of said voltage determining the magnitude of, ΔT, and
o. ΔT being large enough to drive electrons from said plasma through said barrier to the outer surface of said barrier, and
p. said thermoelectric power, P, of said N-Type semiconductor being large enough for said temperature gradient, ΔT, to drive electron transport through said barrier, and
q. said amplitude of said voltage being low enough so that said electrons driven through said barrier appear on said outer surface of said barrier with a kinetic energy below that required to produce ozone in the air, and
r. said air in said second region containing oxygen molecules, O₂, and
s. said electrons being driven through said barrier appearing on said outel surface of said barrier and a portion thereon being captured by O₂ molecules colliding with said outer surface, thus generating superoxide ions, O₂⁻, on said outer surface, said superoxide ions thus emanating into said second region.

102. The method and system of claim one wherein said barrier is composed of borosilicate glass and or pyrex, thus constituting a new use for pyrex.

103. The method and system of claim one wherein said barrier is composed of material selected from the group consisting of chalcogenide glasses such as the sulphides, selenides, and tellurides.

104. The method and system of claim one wherein said barrier is composed of a material selected from the group consisting of glass or ceramic materials which are N-Type semiconductors wherein the majority charge carrier is the electron.

105. The method and system of claim one wherein said barrier is composed of a material selected from the group consisting of transition metal oxide glasses.

106. The method and system of claim one wherein said barrier is composed of a material selected from the group consisting of vanadium phosphate glasses.

107. The method and system of claim one wherein said barrier is composed of a material selected from the group consisting of transition metal oxide glasses wherein the ratio of oxidized valence state transition metal ions to the reduced valence state transition metal ions is adjusted so that the electronic conductivity is at a maximum.

108. The method and system of claim one wherein said barrier is composed of a material selected from the group consisting of classical N-Type semiconductors, wherein the majority charge carrier is the electron.

109. The method and system of claim one wherein said barrier is composed of a material selected from the group consisting of amorphous N-Type semiconductors wherein the majority charge carrier is the electron.

110. The method and system of claim one wherein said second electrode is coated with a thin insulating material so free electrons on the outer surface of said barrier there remain to be absorbed by molecular oxygen, O₂ and said coating thus preventing said electrons from being absorbed by said grounded second electrode before they can be absorbed by said molecular oxygen.

111. The method and system of claim one wherein said gas in said region one is selected from the group consisting of inert gases.

112. The method and system of claim one wherein said gas in said region one has a density greater than air at atmospheric pressure, and standard temperature.

113. The method and system of claim one wherein said gas in said region one is oxygen.

114. The method and system of claim one wherein said barrier has a thickness between 0.5 and 2.5 mm.

115. The method and system of claim one wherein said voltage applied to said first electrode has an amplitude between 2.5-7.0 Kilovolts.

116. The method and system of claim one wherein said voltage applied to said first electrode has an amplitude V, and said amplitude determining the number densities of ions and electrons in said plasma, thus establishing a plasma frequency, fₚ, and said voltage having a frequency near or equal to, fₚ.

117. The method and system of claim one wherein said first and second electrodes have capacitance, C, and said voltage applied to said first electrode is achieved by means of a step up transformer with secondary inductance, L, and said voltage applied to said first electrode has a frequency equal to or within twenty percent of the value, 1/2π√LC.

118. The method and system of claim one wherein said first and second electrodes have capacitance, C, and said voltage applied to said first electrode is achieved by means of a step up transformer with secondary inductance, L, and said voltage applied to said first electrode has a frequency equal to or within twenty percent of the value, 1/2π√LC and equal to or within twenty percent of fₚ.

119. Tile method and system of claim one wherein said voltage applied to second first electrode is a mixture of two frequencies f₁ and f₂ and f₁ is approximately equal to said plasma frequency, fp, and f₂>f₁.

120. The method and system of claim one wherein said voltage applied to second first electrode is a mixture of two frequencies f₁ and f₂ and f₁ is approximately equal to said plasma frequency, fₚ, and f₂ is 500 KHz or larger.

121. The method and system of claim one wherein said voltage applied to second first electrode is a mixture of two frequencies f₁ and f₂ and f₁ is approximately equal to said plasma frequency, fₚ, and f₂ is 1 MHz or larger.

122. The method and system of claim one wherein said voltage applied to second first electrode is a mixture of two frequencies f₁ and f₂ and f₁ is approximately equal to said plasma frequency, fₚ, and f₂ is 10 MHz or larger.

123. The method and system of claim one wherein DC offset tile voltage applied to said first electrode has a negative DC offset.

124. The method and system of claim one wherein the voltage applied to said first electrode has an amplitude, a, and a negative DC offset equal to, b, and |b|>a|.

125. The method and system of claim one wherein said voltage applied to said first electrode is a square pulse waveform with a repetition rate, fᵣ, and fᵣ is approximately equal to the plasma frequency, fₚ.

126. The method and system of claim one wherein said voltage applied to said first electrode is a square pulse waveform with a repetition rate, fᵣ, and fᵣ is approximately equal to the plasma frequency, fₚ, and the waveform is biased at an electric potential that is negative with respect to ground.

127. Tile method and system of claim one wherein said voltage applied to said first electrode is a square pulse waveform with a repetition rate, fᵣ, and fᵣ is approximately equal to the plasma frequency, fₚ, and the inverse of the pulse width is a frequency, f_{w}, and, f_{w}>fₚ.

128. The method and system of claim one wherein said voltage applied to said first electrode is a square pulse waveform with a repetition rate, fᵣ, and fᵣ is approximately equal to the plasma frequency, fp, and the inverse of the pulse width is a frequency, f_{w}, and, f_{w} is at least 500 KHz.

129. The method and system of claim one wherein said voltage applied to said first electrode is a square pulse waveform with a repetition rate, fᵣ, and fᵣ is approximately equal to the plasma frequency, fₚ, and the inverse of the pulse width is a frequency, f_{w}, and, f_{w} is at least 1 MHz.

130. The method and system of claim one wherein said voltage applied to said first electrode is a square pulse waveform with a repetition rate, fᵣ, and fᵣ is approximately equal to the plasma frequency, fₚ, and the inverse of the pulse width is a frequency, f_{w}, and, f_{w} is at least 10 MHz.

131. The method and system of claim one wherein said barrier has thickness d₁, and further includes an outer ceramic coating with thickness, d₂, and d₁>d₂.

132. The method and system of claim one wherein said barrier has thickness d₁, and further includes an outer ceramic coating with thickness, d₂, and d₁>d₂, and said ceramic coating is selected from the group consisting of but not limited to zirconium oxide doped with 8-12 percent yittrium.

133. The method of producing superoxide ions comprising the production of a plasma within an enclosed volume whose boundary is defined by an N-Type semiconductor whose majority charge carrier is the electron, and said plasma thus generating a thermal gradient across said boundary which drives electrons there through onto the outer surface of said boundary where said electrons interact with molecular oxygen to generate the superoxide ion, O₂⁻.
